(19) United States
(12) Patent Application Publication
(10) Pub. No.: US 2021/0088291 A1
(43) Pub. Date: Mar. 25, 2021

(54) TUBULAR BODY ARRANGEMENT FOR A TEMPERATURE-CONTROL DEVICE

(71) Applicant: Mahle International GmbH, Stuttgart (DE)

(72) Inventors: Jochen Eppinger, Waiblingen (DE); Thorsten Mueller, Benningen (DE); Daniel Rothmaier, Maulbronn (DE); Hans Schreiner, Winnenden (DE)

(21) Appl. No.: 17/029,025

(22) Filed: Sep. 22, 2020

(30) Foreign Application Priority Data
Sep. 23, 2019 (DE) 102019214497.7

(51) Int. Cl. F28F 1/00; F28D 7/00

(52) U.S. Cl. CPC F28F 1/006; F28D 7/0041

(57) ABSTRACT

A tubular body arrangement for a temperature-control device, e.g., for temperature-controlling an electrical device, is disclosed. The tubular body arrangement includes at least one first tubular body and at least one second tubular body that can each be flowed through by a temperature-control fluid and that each include a circumferential wall extending along an axial direction. The first tubular body has a first tube flange that is deformable for compensating for at least one of a position change and a dimensional change of an axial length of at least one of the tubular bodies. The first tube flange projects from the circumferential wall of the first tubular body at an angle. The second tubular body is mounted on the first tube flange so that the first tubular body and the second tubular body jointly bound a tubular body interior that can be flowed through by the temperature-control fluid.

### CROSS-REFERENCE TO RELATED APPLICATION

This application claims priority to German Application No. DE 10 2019 214 497.7 filed on Sep. 23, 2019, the contents of which are hereby incorporated by reference in its entirety.

### TECHNICAL FIELD

The invention relates to a tubular body arrangement for a temperature-control device and to a temperature-control device having such a tubular body arrangement. In addition, the invention relates to an electrical device having such a temperature-control device.

### BACKGROUND

Temperature-control devices for electrical devices comprising tubular bodies have been known for some time. Usually, such tubular bodies are flowed through by a temperature-control device fluid for temperature-controlling the electrical device. Depending on whether the electrical device is to be heated or cooled by means of the temperature-control device, this temperature-control fluid can absorb heat from the electrical device or pass heat on to the electrical device. However it cannot be avoided in the process that heat is also transferred between the temperature-control fluid and the tubular body while flowing through the tubular body. As a consequence of this heat transfer from the temperature-control fluid to the tubular body or from the tubular body to the temperature-control fluid, the tubular body is heated or cooled. Such a heating or cooling of the tubular body causes a length change of the tubular body or a position change of the tubular body relative to the further components of the electrical device or of the temperature-control device as a consequence of a heat expansion or heat shrinkage of the tubular body.

Before this background, tubular bodies or tubular body arrangements having such tubular bodies for temperature-control devices are usually formed with bellows-like or corrugated tube-like buffer sections, which are deformable for compensating for the heat expansion.

Disadvantageously however, such corrugated tube or bellows sections with their complex geometries of necessity form undercuts in a tubular body interior bounded by the tubular body, so that such tubular bodies are complicated and thus cost-intensive in the production. Apart from this, a flow of the temperature-control fluid flowing through the tubular body interior is negatively influenced by the corrugated tube or bellows sections.

### SUMMARY

It is therefore an object of the present invention to show new ways for tubular body arrangements for a temperature-control device and for temperature-control devices having such a tubular body arrangement and for electrical devices having such temperature-control devices—in particular for eliminating the abovementioned disadvantages.

This object is solved through the independent claim(s) and through the subsidiary patent claims. Preferred embodiments are subject of the dependent claims.

Accordingly, the basic idea of the invention is to provide a tubular body arrangement for a temperature-control device for temperature-controlling an electrical device, in the case of which a second tubular body is mounted to a tubular body flange of a first tubular body for the joint bounding of a tubular body interior, wherein the first tube flange of the first tubular body is deformable for compensating for a heat expansion of at least one of the tubular bodies.

In the tubular body interior of the individual tubular bodies taken by itself no undercuts are advantageously present—contrary to the corrugated tube or bellows sections of conventional tubular bodies for temperature-control devices. This is accompanied by a significantly improved producibility of the tubular bodies for the tubular body arrangement, so that these can be cost-effectively produced in large quantities by means of a primary moulding method such as injection moulding. In addition to this, the modular construction of the tubular body arrangement of first and second tubular bodies makes possible a variable adaptation of a tubular body arrangement length by simply adding or omitting individual tubular bodies.

A tubular body arrangement according to the invention, which is employable for a temperature-control device, which in turn serves for temperature-controlling an electrical device, comprises at least one first and at least one second tubular body. The at least one first and at least one second tubular body can be flowed through by a temperature-control fluid. Said temperature-control fluid can be a liquid or gas. Each of the tubular bodies comprises a circumferential wall which extend along an axial direction. Practically, the first and/or the second tubular body comprise a plastic or consist of a plastic. For compensating for a position change and/or a dimensional change of an axial length measured along the axial direction of at least one of the tubular bodies, a first tube flange is present on the first tubular body, which projects from the circumferential wall of the first tubular body at an angle and which for accommodating the length change or for compensating for the position change is deformable. On this first tube flange of the first tubular body, the second tubular body is mounted on a side of the first tube flange of the first tubular body facing away from the circumferential wall of the first tubular body. Practically, the second tubular body is mounted to the first tube flange of the first tubular body in a firmly bonded manner. The second tubular body is mounted to the first tube flange of the first tubular body in such a manner that the two tubular bodies jointly bound a tubular body interior through which the temperature-control fluid can flow. Preferably, the tubular body arrangement does not comprise any separate sealing element. Advantageously, a bellows section can thus be omitted which on the one hand, because of its complex geometry, can only be produced with difficulty and accordingly with significant costs and which moreover negatively influences a flow of the temperature-control fluid through the tubular body interior can be omitted. In other words, in terms of flow, such a tubular body arrangement can be particularly favourably embodied and particularly cost-effectively produced in terms of manufacture.

Practically, a thin area is present on the first tube flange of the first tubular body which particularly practically is circumferentially formed along a circumferential direction of the first tubular body. In the thin area of the first tube flange of the first tubular body, a flange thickness of the first tube flange is reduced compared with a wall thickness of the circumferential wall of the first tubular body. Thus, the thin area of the first tube flange forms a predetermined deformation area of the first tubular body. Advantageously, a position change or a length change of at least one of the tubular bodies of the tubular body arrangement can be particularly favourably compensated for with a tube flange formed in such a manner.

According to an advantageous further development of the tubular body arrangement, a second tube flange projecting from the circumferential wall of the second tubular body at an angle is present on the second tubular body for mounting the second tubular body to the first tube flange of the first tubular body. The second tube flange of the second tubular body lies against the tube flange of the first tubular body and is mounted to this first tube flange of the first tubular body. Advantageously, by means of such a second tube flange of the second tubular body, the second tubular body can be particularly easily positioned relative to the first tubular body and mounted to the first tube flange of the first tubular body.

According to a preferred further development of the tubular body arrangement, the circumferential wall of the first tubular body and the circumferential wall of the second tubular body are arranged along the axial direction at an axial deformation compensation distance to one another. Between the tube flanges of the first and of the second tubular body, a circumferential deformation compensation space is thus formed. Advantageously, this makes possible compensating for both a positive and also a negative length change of at least one of the tubular bodies of the tubular body arrangement.

Practically, the second tube flange of the second tubular body is formed in such a manner that the second tube flange of the second tubular body radially projects perpendicularly to the circumferential wall of the second tubular body from the same radially to the outside. Such a second tube flange projecting perpendicularly from the circumferential wall is particularly easily and accordingly cost-effectively producible.

A preferred further development of the tubular body arrangement provides that on the second tube flange of the second tubular body a continuation is arranged, which projects in the axial direction from the second tube flange of the second tubular body in the direction of the first tubular body. Practically, the continuation that is present on the second tube flange is formed circumferentially along a circumferential direction. In the tubular body arrangement, the continuation is arranged radially between the deformation compensation space and the tubular body interior. The continuation that is present on the second tube flange of the second tubular body advantageously serves as flow guiding element, by means of which a flow resistance, against which the temperature-control fluid flows through the tubular body interior, can be reduced.

According to a further advantageous further development, a continuation is arranged on the first tube flange of the first tubular body, which axially projects from the first tube flange of the first tubular body in the direction of the second tubular body. Practically, this continuation of the first tube flange of the first tubular body is formed circumferentially along the circumferential direction. In the tubular body arrangement, the continuation that is present on the first tube flange of the first tubular body is arranged radially between the deformation compensation space and the tubular body interior. It is to be understood that both on the first tube flange of the first tubular body and also on the second tube flange of the second tubular body or on only one of these tube flanges such a continuation can be present. Advantageously, the continuation that is present on the first tube flange of the first tubular body reduces a flow resistance against which the temperature-control fluid flowing through the tubular body interior flows.

In a further advantageous further development of the tubular body arrangement, the first tube flange of the first tubular body has a rounded region. In this rounded region of the first tube flange of the first tubular body, the first tube flange merges into the circumferential wall at a first end of the circumferential wall of the first tubular body facing the first tube flange. In the rounded region of the first tube flange of the first tubular body, the thin area of the first tube flange is present. A thin area of the first tube flange of the first tubular body formed rounded in this manner is particularly favourably deformable for compensating for the position change or the length change of at least one of the tubular bodies of the tubular body arrangement.

A further preferred further development of the tubular body arrangement provides that the first tubular body comprises a second tube flange at a second end of the first tubular body facing away from the first tube flange of the first tubular body. This second tube flange of the first tubular body is formed in the same manner as the second tube flange of the second tubular body. Advantageously, a further tubular body can thus be mounted to the second tube flange of the first tubular body.

In a further advantageous further development of the tubular body arrangement, the second tubular body comprises a first tube flange at the first end of the second tubular body facing away from the second tube flange of the second tubular body. This first tube flange of the second tubular body is formed in the same manner as the first tube flange of the first tubular body. Advantageously, a further tubular body can thus be mounted to the first tube flange of the second tubular body.

Practically, the first and the second tubular body are formed as identical parts. Thus, cost advantages materialise since both the first and also the second tubular body are producible by means of one and the same manufacturing method and by means of one and the same manufacturing plants. Apart from this, the tubular body arrangement can, depending on application requirement, be complemented by any number of first or second tubular bodies.

According to a further advantageous further development of the tubular body arrangement, an opening is present in the circumferential wall of the first and/or of the second tubular body, which radially penetrates the circumferential wall of the respective tubular body. By way of this opening radially penetrating the respective circumferential wall, the temperature-control fluid flowing through the tubular body interior can be conducted out of the tubular body interior or conducted into this tubular body interior. Advantageously, the tubular body arrangement can thus form a fluid distributor or a fluid collector for a temperature-control device having such a tubular body arrangement.

In addition, the invention relates to a temperature-control device for temperature-controlling an electrical device. The temperature-control device comprises at least one tubular body arrangement according to the invention as per the preceding description. There, the tubular body arrangement forms a fluid distributor for distributing a temperature-control fluid that is present in the tubular body interior over multiple cooling spaces of the temperature-control device. One each of the cooling spaces of the temperature-control device is fluidically communicatingly connected to the tubular body interior via the opening which radially penetrates the circumferential wall of at least one tubular body of the tubular body arrangement. Alternatively or additionally, the tubular body arrangement or a further such tubular body arrangement forms a fluid collector of the temperature-control device, by means of which the temperature-control fluid from the multiple cooling spaces of the temperature-control device that is present in the tubular interior is collected. One each of the cooling spaces of the temperature-control device is fluidically communicatingly connected to the tubular body interior by way of the opening that radially penetrates the circumferential wall of at least one tubular body of the tubular body arrangement. The previously shown advantages of the tubular body arrangement according to the invention apply analogously also to the temperature-control device according to the invention having such a tubular body arrangement.

In an advantageous further development of the temperature-control device, the tubular body arrangement comprises at least one further first and/or second tubular body. Practically, the tubular body arrangement of the temperature-control device comprises multiple such additional first and/or second tubular bodies. There, the first and the second tubular bodies are alternately arranged and mounted to one another. The first and the second tubular bodies are alternately arranged and mounted to one another in such a manner that all tubular bodies of the tubular body arrangement jointly bound the tubular body interior. Advantageously, the tubular body arrangement can, while forming the fluid collector or fluid distributor of the temperature-control device, be particularly easily matched to an electrical device to be temperature-controlled by means of the temperature-control device with the help of a number of first or second tubular bodies matched to the same.

In addition to this, the invention relates to an electrical device which practically is an electric battery. The electrical device comprises a temperature-control device according to the invention as per the preceding description. In addition, the electrical device comprises multiple electrical cells arranged at a distance from one another, wherein between two neighbouring cells a cooling space of the temperature-control device is present. Particularly practically, such a cooling space of the temperature-control device each is present between all neighbouring cells of the electrical device. The advantages of the temperature-control device according to the invention shown above analogously apply also to the electrical device having such a temperature-control device according to the invention.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 an example of a tubular body arrangement according to the invention in a longitudinal section along an axial direction,

FIG. 2 an example of a temperature-control device according to the invention having an exemplary tubular body arrangement according to the invention in a perspective representation,

FIG. 3 an example of an electrical device according to the invention with an exemplarily shown temperature-control device according to the invention in a perspective representation.

### DETAILED DESCRIPTION

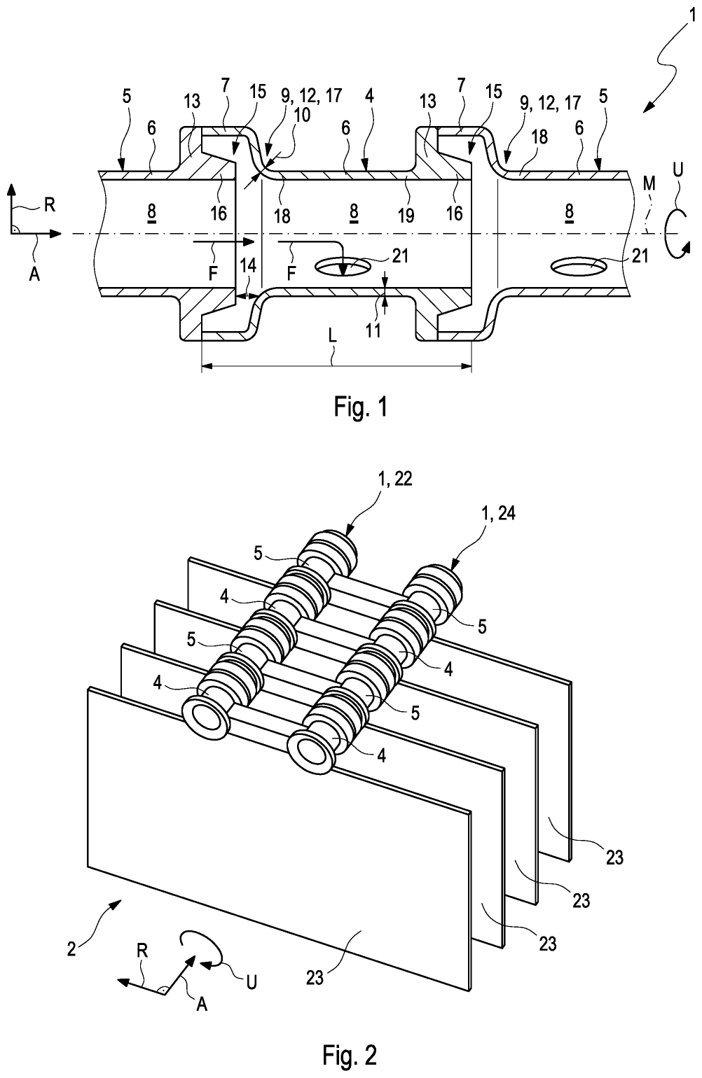

In FIG. 1, a tubular body arrangement 1 for a temperature-control device 2 according to the invention is exemplarily shown in a longitudinal section along an axial direction A. The temperature-control device 2 can be employed for temperature-controlling an electrical device 3. The tubular body arrangement 1 comprises at least one first tubular body 4 and at least one second tubular body 5, which are equipped for being flowed through by a temperature-control fluid F. Said temperature-control fluid F can be a gas or a liquid. Each of the tubular bodies 4, 5 comprises a circumferential wall 6, which extends along the axial direction A. The axial direction A extends along a centre longitudinal axis M of the first tubular body 4. Perpendicularly to the axial direction A, a radial direction R extends away from the centre longitudinal axis M. A circumferential direction U extends perpendicularly to the radial direction R and perpendicularly to the axial direction A and circulates about the centre longitudinal axis M. For compensating for a position change and/or a dimensional change of an axial length L measured along the axial direction A of at least one of the tubular bodies 4, 5, a deformable first tube flange 7 projecting from its circumferential wall 6 at an angle is present on the first tubular body 4. The first tube flange 7 of the first tubular body 4 is deformable for accommodating the length change of the axial length L measured along the axial direction A of at least one of the tubular bodies 4, 5 or the position change of one of the tubular bodies 4, 5. By means of the deformation of the first tube flange 7 of the first tubular body 4, the position change and/or dimensional change of at least one of the tubular bodies 4, 5 can be compensated for. Such a position change and/or dimensional change can materialise for example as a consequence of a temperature expansion of at least one of the tubular bodies 4, 5. Facing away from the circumferential wall 6 of the first tubular body 4, the second tubular body 5 is mounted to the first tube flange 7 of the first tubular body 4. Tubular body arrangement 1 can be formed without any additional sealing element or gasket.

The second tubular body 5 can be mounted to the tube flange 7 of the first tubular body 4 in a firmly bonded manner. The second tubular body 5 can be welded or glued to the first tube flange 7 of the first tubular body 4. Here, the second tubular body 5 is mounted to the first tube flange 7 of the first tubular body 4 in such a manner that the two tubular bodies 4, 5 jointly bound a tubular body interior 8 that can be flowed through by the temperature-control fluid F. On the first tube flange 7 of the first tubular body 4 a thin area 9 can be present. In the thin area 9 of the first tube flange 7 of the first tubular body 4, a flange thickness 10 of the first tube flange 7 is reduced compared with a wall thickness 11 of the circumferential wall 6 of the first tubular body 4. The flange thickness 10 of the first tube flange 7 can be reduced relative to the wall thickness 11 of the circumferential wall 6 of the first tubular body 4 in such a manner that a predetermined deformation area 12 is created by the thin area 9. The thin area 9 can be circumferentially formed, in particular completely, along the circumferential direction U. On the second tubular body 5, a second tube flange 13 can be present on the first tube flange 7 of the first tubular body 4 for fastening the second tubular body 5. The second tube flange 13 can be formed projecting from the circumferential wall 6 of the second tubular body 5 at an angle. The second tube flange 13 of the second tubular body 5 can project, perpendicularly to the circumferential wall 6 of the second tubular body 5, along the radial direction R to the outside.

The first tube flange 7 of the first tubular body 4 can be mounted lying against the second tube flange 13 of the second tubular body 5. To this end, a welding geometry can be present on the first tube flange 7 of the first tubular body 4 and—alternatively or additionally—on the second tube flange 13 of the second tubular body 5, by means of which the first tubular body 4 and the second tubular body 5 can be welded to one another. The welding geometry can be designed for connecting the first tubular body 4 to the second tubular body 5 by means of an ultrasound welding method.

In the tubular body arrangement 1, the circumferential wall 6 of the first tubular body 4 and the circumferential wall 6 of the second tubular body 5 can be arranged along the axial direction A relative to one another at an axial deformation distance 14 measured along the axial direction A. Here, the first tubular body 4 and the second tubular body 5 can be arranged at the axial deformation compensation distance 14 relative to one another so that between the tube flanges 7, 13 a circumferential deformation compensation space 15 is formed.

On the second tube flange 13 of the second tubular body 5, a continuation 16, directed in the axial direction A towards the first tubular body 4, can be arranged. The continuation 16 can be formed circumferentially projecting from the second tube flange 13 along the circumferential direction U. The continuation 16, seen in the radial direction, can be arranged between the deformation compensation space 15 and the tubular body interior 8. Alternatively or additionally—which for the sake of clarity however is not shown in the figures—a continuation 16 can be axially arranged on the first tube flange 7 of the first tubular body 4 in the direction of the second tubular body 5. This continuation 16 arranged on the first tube flange 7 can be formed circumferentially along the circumferential direction. The continuation 16 that is present on the first tube flange 7 can be arranged, seen in the radial direction, between the deformation compensation space 15 and the tubular body interior 8.

The first tube flange 7 of the first tubular body 4 can comprise a rounded region 17. In the rounded region 17 of the first tube flange 7 of the first tubular body 4, the first tube flange 7 can merge, at a first end of the circumferential wall 6 of the first tubular body 4 facing the first tube flange 7, into the circumferential wall 6. In the rounded region 17 of the first tube flange 7, the thin area 9 of the first tube flange 7 can be formed. The rounded region 17 with the thin area 9 of the first tube flange 7 can be formed circumferentially along the circumferential direction U. On the first tubular body 4, a second tube flange 13 can be present at a second end 19 of the first tubular body 4 facing away from the first tube flange 7 of the first tubular body 4. This second tube flange 13 of the first tubular body 4 can be formed in the same manner as the second tube flange 13 of the second tubular body 5. At the first end 18 of the second tubular body 5 facing away from the second tube flange 13 of the second tubular body 5, the second tubular body 5 can comprise a first tube flange 7. This first tube flange 7 of the second tubular body can be formed in the same manner as the first tube flange 7 of the first tubular body 4. The first and the second tubular body 4, 5 can be formed as identical parts.

In the circumferential wall 6 of the first and second tubular body 4, 5, an opening 21 can be present, which radially penetrates the circumferential wall 6 of the respective tubular body 4, 5. The temperature-control fluid F flowing through the tubular body interior 8 can be conducted out of the tubular body interior 8 or conducted into the tubular body interior 8 through this opening 21 radially penetrating the circumferential wall 6 of the respective tubular body 4, 5. The circumferential wall 6 of the first and of the second tubular body 4, 5 can additionally comprise a bellows-like or corrugated tube-like deformation compensation portion which however is not shown in FIG. 1. Likewise not shown is that the tubular body arrangement 1 can comprise a third tubular body having such a bellows-like or corrugated tube-like portion.

FIG. 2 exemplarily illustrates a temperature-control device 2 according to the invention in a perspective representation. The temperature-control device 2 comprises at least one tubular body arrangement 1 according to the preceding description. In the concrete example of FIG. 2, the temperature-control device 2 comprises two such tubular body arrangements 1. The temperature-control device 2 additionally comprises multiple cooling spaces 23. A first tubular body arrangement 1 of the temperature-control device 2 forms a fluid distributor 22 for distributing a temperature-control fluid F present in the tubular body interior 8 over the multiple cooling spaces 23 of the temperature-control device 2. One each of the multiple cooling spaces 23 of the temperature-control device 2 is fluidically communicatingly connected to the tubular body interior 8 via the openings 21 radially penetrating the circumferential wall 6 of at least one of the tubular bodies 4, 5 of the tubular body arrangement 1. Alternatively or additionally, the temperature-control device 2 comprises a second tubular body arrangement 1, which forms a fluid collector 24 for collecting the temperature-control fluid that is present in the tubular interior 8 from the multiple cooling spaces 23. There, one each of the multiple cooling spaces 23 of the temperature-control device 2 is fluidically communicatingly connected to the tubular body interior 8 of the respective tubular body arrangement 1 by way of the openings 21 radially penetrating the circumferential wall 6 of at least one of the tubular bodies 4, 5 of the tubular body arrangement 1.

As is shown in FIG. 2, the tubular body arrangement 1 can comprise at least one further first and one further second tubular body 4, 5. According to the shown example, the tubular body arrangement 1 can comprise multiple first and/or second tubular bodies 4, 5. The first and the second tubular bodies 4, 5 can be alternately arranged and mounted to one another. The first and second tubular bodies can be alternately arranged and mounted to one another in such a manner that all tubular bodies 4, 5 of the tubular body arrangement jointly bound the tubular body interior 8.

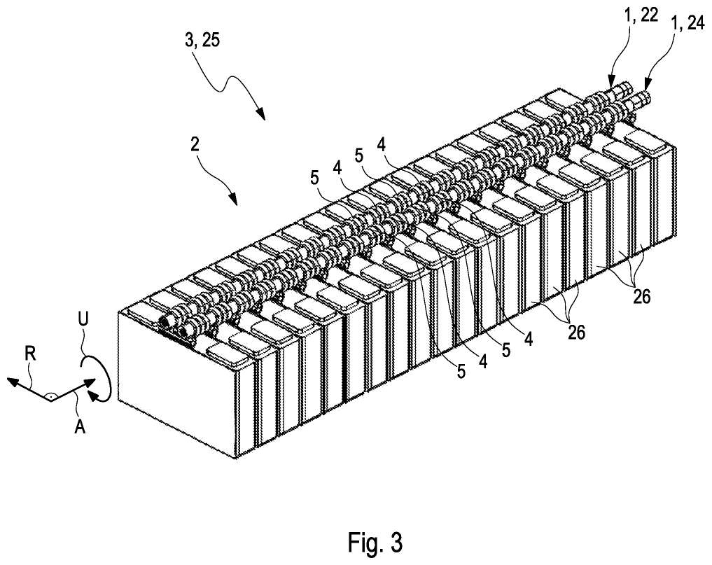

FIG. 3 exemplarily illustrates in a perspective representation an electrical device 3 which comprises a temperature-control device 2 according to the invention. The electrical device 3 can be an electric battery 25. The electrical device 3 comprises multiple electrical cells 26 arranged at a distance from one another. The electrical cells 26 of the electrical device 3 can be arranged stack-like along a stack direction. The stack direction can run along the axial direction A of the at least one tubular body arrangement 1 of the temperature-control device 2. Between at least two neighbouring cells 26 of the electrical device 3, one of the cooling spaces 23 of the temperature-control device 2 is present. Between all neighbouring cells 26 of the electrical device 3, such a cooling space 23 of the temperature-control device 2 can be present.

1. A tubular body arrangement for a temperature-control device, comprising:
at least one first tubular body and at least one second tubular body, each being flowable through by a temperature-control fluid and each including a circumferential wall extending along an axial direction,
wherein the at least one first tubular body has a first tube flange that is deformable for compensating for at least one of a position change and a dimensional change of an axial length measured along the axial direction at least one of the tubular bodies, the first tube flange projecting from the circumferential wall of the at least one first tubular body at an angle, and wherein the at least one second tubular body is mounted on the first tube flange and faces away from the circumferential wall of the at least one first tubular body so that the at least one first tubular body and the at least one second tubular body jointly bound a tubular body interior that can be flowed through by the temperature-control fluid.

2. The tubular body arrangement according to claim 1, wherein a thin area is present on the first tube flange of the at least one first tubular body, in which a flange thickness of the first tube flange relative to a wall thickness of the circumferential wall of the at least one first tubular body is reduced, so that through the thin area a predetermined deformation area is provided.

3. The tubular body arrangement according to claim 1, wherein the at least one second tubular body comprises, for mounting the at least one second tubular body on the first tube flange of the at least one first tubular body, a second tube flange projecting at an angle from the circumferential wall of the at least one second tubular body, against which the first tube flange of the at least one first tubular body lies and is mounted.

4. The tubular body arrangement according to claim 3, wherein the circumferential wall of the at least one first tubular body and the circumferential wall of the at least one second tubular body are arranged along the axial direction at an axial deformation compensation distance measured along the axial direction, so that a circumferential deformation compensation space is formed between the first tube flange and the second tube flange.

5. The tubular body arrangement according to claim 3, wherein the second tube flange of the at least one second tubular body projects perpendicularly to the circumferential wall of the at least one second tubular body, and radially to the outside.

6. The tubular body arrangement according claim 3, wherein, on the second tube flange of the at least one second tubular body, in the axial direction towards the at least one first tubular body, a continuation is arranged, the continuation radially arranged between a deformation compensation space formed between the first tube flange and the second tube flange and the tubular body interior.

7. The tubular body arrangement according to claim 4, wherein, on the first tube flange of the at least one first tubular body, axially in a direction of the at least one second tubular body, a continuation is arranged, the continuation being radially arranged between the deformation compensation space and the tubular body interior.

8. The tubular body arrangement according to claim 1, wherein the first tube flange of the at least one first tubular body has a rounded region, via which the first tube flange, at a first end of the circumferential wall of the at least one first tubular body, facing the first tube flange, merges into the circumferential wall and in which a thin area of the first tube flange is present.

9. The tubular body arrangement according to claim 4, wherein the at least one first tubular body, at a second end of the at least one first tubular body facing away from the first tube flange of the at least one first tubular body, has a further tube flange.

10. The tubular body arrangement according to claim 4, wherein the at least one second tubular body, at the first end of the at least one second tubular body facing away from the second tube flange of the at least one second tubular body, includes a further tube flange.

11. The tubular body arrangement according to claim 1, wherein the at least one first tubular body and the at least one second tubular body are formed as identical parts.

12. The tubular body arrangement according to claim 1, wherein, in the circumferential wall of at least one of the at least one first tubular body and the at least one second tubular body, an opening radially penetrating the circumferential wall is present, through which the temperature-control fluid flowing through the tubular body interior can be conducted out of or conducted into the tubular body interior.

13. A temperature-control device, comprising: at least one tubular body arrangement, the at least one tubular body arrangement including:
at least one first tubular body and at least one second tubular body, each being flowable through by a temperature-control fluid and each including a circumferential wall extending along an axial direction;
wherein the at least one first tubular body has a first tube flange that is deformable for compensating for at least one of a position change and a dimensional change of an axial length measured along the axial direction at least one of the tubular bodies, the first tube flange projecting from the circumferential wall of the at least one first tubular body at an angle, and wherein the at least one second tubular body is mounted on the first tube flange and faces away from the circumferential wall of the at least one first tubular body so that the at least one first tubular body and the at least one second tubular body jointly bound a tubular body interior that can be flowed through by the temperature-control fluid;
wherein an opening is provided in the circumferential wall of at least one of the at least one first tubular body and the at least one second tubular body, the opening radially penetrating the circumferential wall such that the temperature-control fluid flowing through the tubular body interior can be conducted out of or into the tubular body interior;
wherein at least one of:
the at least one tubular body arrangement forms a fluid distributor for distributing the temperature-control fluid that is present in the tubular body interior over multiple cooling spaces, the cooling spaces each being fluidically communicatingly connected to the tubular body interior via the opening radially penetrating the circumferential wall of the at least one of the at least one first tubular body and the at least one second tubular body; and
the tubular body arrangement forms a fluid collector for collecting the temperature-control fluid that is present in the tubular body interior from the multiple cooling spaces of the temperature-control device, the cooling spaces each being fluidically communicatingly connected to the tubular body interior via the opening radially penetrating the circumferential wall of the at least one of the at least one first tubular body and the at least one second tubular body.

14. The temperature-control device according to claim 13, wherein the tubular body arrangement further includes at least one of a further first tubular body and a further second tubular body, wherein the at least one first tubular body and the at least one second tubular body are alternately arranged and mounted to one another such that all of tubular bodies of the tubular body arrangement jointly bound the tubular body interior.

15. An electrical device, comprising: a temperature-control device, the temperature-control device including at least one tubular body arrangement that includes:
at least one first tubular body and at least one second tubular body, each being flowable through by a temperature-control fluid and each including a circumferential wall extending along an axial direction;
wherein the at least one first tubular body has a first tube flange that is deformable for compensating for at least one of a position change and a dimensional change of an axial length measured along the axial direction at least one of the tubular bodies, the first tube flange projecting from the circumferential wall of the at least one first tubular body at an angle, and wherein the at least one second tubular body is mounted on the first tube flange and faces away from the circumferential wall of the at least one first tubular body so that the at least one first tubular body and the at least one second tubular body jointly bound a tubular body interior that can be flowed through by the temperature-control fluid;
wherein an opening is provided in the circumferential wall of at least one of the at least one first tubular body and the at least one second tubular body, the opening radially penetrating the circumferential wall such that the temperature-control fluid flowing through the tubular body interior can be conducted out of or into the tubular body interior;
wherein at least one of:
the at least one tubular body arrangement forms a fluid distributor for distributing the temperature-control fluid that is present in the tubular body interior over multiple cooling spaces, the cooling spaces each being fluidically communicatingly connected to the tubular body interior via the opening radially penetrating the circumferential wall of the at least one of the at least one first tubular body and the at least one second tubular body; and
the tubular body arrangement forms a fluid collector for collecting the temperature-control fluid that is present in the tubular body interior from the multiple cooling spaces of the temperature-control device, the cooling spaces each being fluidically communicatingly connected to the tubular body interior via the opening radially penetrating the circumferential wall of the at least one of the at least one first tubular body and the at least one second tubular body;
a plurality of electrical cells arranged at a distance from one another, wherein between at least two neighbouring cells a cooling space of the temperature-control device is present.

16. The electrical device according to claim 15, wherein a thin area is present on the first tube flange of the at least one first tubular body, the thin area having a flange thickness of the first tube flange that is reduced relative to a wall thickness of the circumferential wall of the at least one first tubular body, so that through the thin area a predetermined deformation area is provided.

17. The temperature-control device according to claim 13, wherein a thin area is present on the first tube flange of the at least one first tubular body, the thin area having a flange thickness of the first tube flange that is reduced relative to a wall thickness of the circumferential wall of the at least one first tubular body, so that through the thin area a predetermined deformation area is provided.

18. The temperature-control device according to claim 13, wherein the at least one second tubular body includes a second tube flange projecting at an angle from the circumferential wall of the at least one second tubular body, against which the first tube flange of the at least one first tubular body lies and is mounted.

19. The temperature-control device according to claim 18, wherein the circumferential wall of the at least one first tubular body and the circumferential wall of the at least one second tubular body are arranged along the axial direction at an axial deformation compensation distance measured along the axial direction, such that a circumferential deformation compensation space is provided between the first tube flange and the second tube flange.

20. The temperature-control device according to claim 19, wherein the second tube flange of the at least one second tubular body projects perpendicularly to the circumferential wall of the at least one second tubular body and radially to the outside.
